(19) United States
(12) Patent Application Publication
(10) Pub. No.: US 2025/0226149 A1
(43) Pub. Date: Jul. 10, 2025

(54) MAGNETIC COMPONENT, ELECTRIC CIRCUIT AND POWER CONVERSION CIRCUIT

(71) Applicant: KABUSHIKI KAISHA TOSHIBA, Tokyo (JP)

(72) Inventors: Keigo ARITA, Kawasaki (JP); Tatsunori SAKANO, Tokyo (JP)

(73) Assignee: KABUSHIKI KAISHA TOSHIBA, Tokyo (JP)

(21) Appl. No.: 18/967,789

(22) Filed: Dec. 4, 2024

(30) Foreign Application Priority Data
Jan. 4, 2024 (JP) 2024-000337

(51) Int. Cl. H01F 27/34; H01F 27/28; H02M 3/06; H02M 3/158

(52) U.S. Cl. CPC H01F 27/34; H01F 27/2823; H02M 3/06; H02M 3/1582

(57) ABSTRACT

According to one embodiment, a magnetic component includes a magnetic core portion, a first conductive member, and a second conductive member. The magnetic core portion includes a first core, a second core, a third core, and a fourth core. The first conductive member includes a first conductive portion and a second conductive portion. The first conductive portion is wound around the first core in a first winding direction. The second conductive portion is wound around the second core in a second winding direction. The second winding direction is opposite to the first winding direction. The second conductive member includes a third conductive portion and a fourth conductive portion. The third conductive portion is wound around the third core in a third winding direction. The fourth conductive portion is wound around the fourth core in a fourth winding direction. The fourth winding direction is opposite to the third winding direction.

### CROSS-REFERENCE TO RELATED APPLICATIONS

This application is based upon and claims the benefit of priority from Japanese Patent Application No. 2024-000337, filed on Jan. 4, 2024; the entire contents of which are incorporated herein by reference.

### FIELD

Embodiments described herein relate generally to a magnetic component, an electric circuit, and a power conversion circuit.

### BACKGROUND

For example, magnetic components including a conductive member wound around a magnetic core are used in power conversion circuits and the like. It is desired to reduce loss in magnetic components.

### BRIEF DESCRIPTION OF THE DRAWINGS

FIG. 1 is a schematic view illustrating a magnetic component according to a first embodiment;

FIG. 2 is a schematic view illustrating the magnetic component according to the first embodiment;

FIG. 3 is a schematic view illustrating the magnetic component according to the first embodiment;

FIG. 4 is a schematic view illustrating the magnetic component according to the first embodiment;

FIG. 5 is an equivalent circuit diagram illustrating the magnetic component according to the first embodiment;

FIG. 6 is an equivalent circuit diagram illustrating the magnetic component of a second reference example;

FIG. 7 is a schematic perspective view illustrating a magnetic component according to the first embodiment;

FIG. 8 is a schematic perspective view illustrating a magnetic component according to the first embodiment;

FIG. 9 is a schematic perspective view illustrating a magnetic component according to the first embodiment;

FIG. 10 is a schematic perspective view illustrating a magnetic component according to the first embodiment;

FIG. 11 is an equivalent circuit diagram illustrating a power conversion circuit according to a third embodiment;

FIGS. 12A and 12B are graphs illustrating the characteristics of the power conversion circuit according to the third embodiment;

FIG. 13 is an equivalent circuit diagram illustrating a power conversion circuit according to the third embodiment;

FIG. 14 is an equivalent circuit diagram illustrating a power conversion circuit according to the third embodiment;

FIG. 15 is an equivalent circuit diagram illustrating a power conversion circuit according to the third embodiment; and

FIG. 16 is an equivalent circuit diagram illustrating a power conversion circuit according to the third embodiment.

### DETAILED DESCRIPTION

According to one embodiment, a magnetic component includes a magnetic core portion, a first conductive member, and a second conductive member. The magnetic core portion includes a first core, a second core, a third core, and a fourth core. A first direction from the first core to the fourth core crosses a second direction from the first core to the third core. A direction from the third core to the second core is along the first direction. A direction from the fourth core to the second core is along the second direction. A first distance between the first core and the fourth core is same as a third distance between the first core and the third core. The first distance is same as a second distance between the third core and the second core. The first distance is same as a fourth distance between the fourth core and the second core. The first conductive member includes a first conductive portion and a second conductive portion. The first conductive portion is wound around the first core in a first winding direction. The second conductive portion is wound around the second core in a second winding direction. The second winding direction is opposite to the first winding direction. The second conductive member includes a third conductive portion and a fourth conductive portion. The third conductive portion is wound around the third core in a third winding direction. The fourth conductive portion is wound around the fourth core in a fourth winding direction. The fourth winding direction is opposite to the third winding direction.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

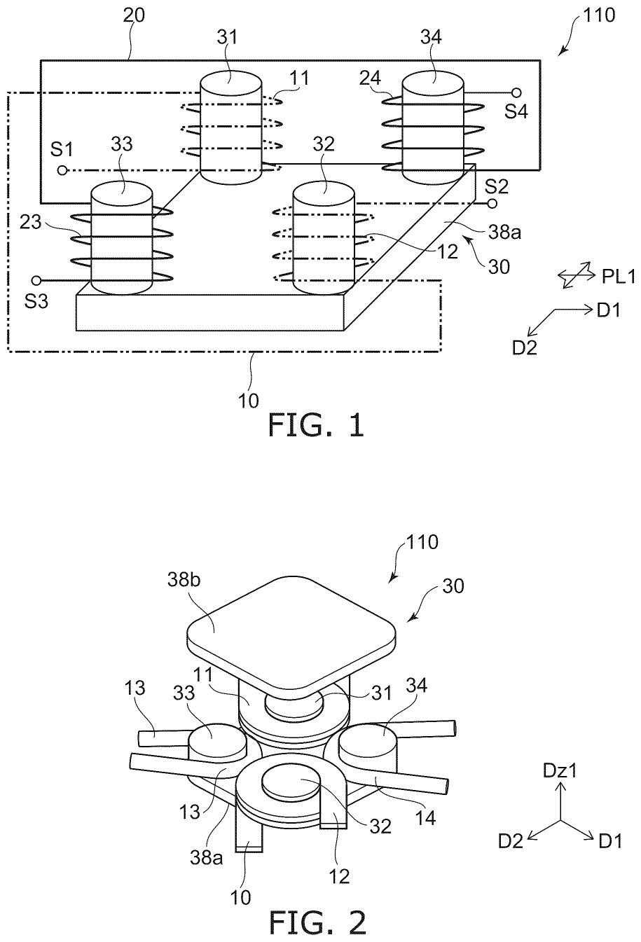

FIGS. 1 to 4 are schematic views illustrating a magnetic component according to a first embodiment.

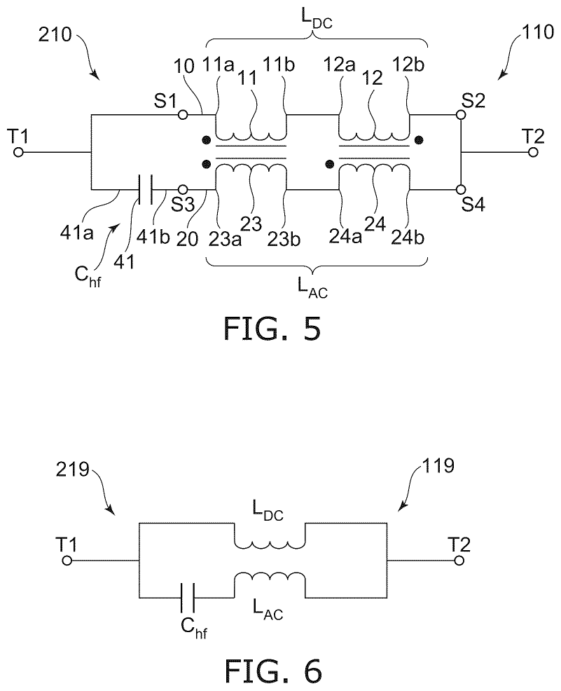

FIG. 5 is an equivalent circuit diagram illustrating the magnetic component according to the first embodiment.

FIGS. 1 to 3 are perspective views. FIG. 4 is a plan view illustrating a part of the magnetic component.

As shown in FIG. 1, a magnetic component 110 according to the embodiment includes a magnetic core portion 30, a first conductive member 10, and a second conductive member 20. The magnetic core portion 30 includes a first core 31, a second core 32, a third core 33, and a fourth core 34.

FIG. 4 illustrates these cores. Ae first direction D1 from the first core 31 to the fourth core 34 crosses a second direction D2 from the first core 31 to the third core 33. A direction from the third core 33 to the second core 32 is along the first direction D1. A direction from the fourth core 34 to the second core 32 is along the second direction D2. An angle between the first direction D1 and the second direction D2 is arbitrary. The second direction D2 may be inclined with respect to or perpendicular to the first direction D1.

A distance between the first core 31 and the fourth core 34 is defined as a first distance d1. The first distance d1 is the same as a third distance d3 between the first core 31 and the third core 33. The first distance d1 is the same as a second distance d2 between the third core 33 and the second core 32. The first distance d1 is the same as a fourth distance d4 between the fourth core 34 and the second core 32. A plane including the first direction D1 and the second direction D2 is defined as a first plane PL1. These distances may be distances related to the center position of each of the plurality of cores in the first plane PL1.

The first core 31, the second core 32, the third core 33, and the fourth core 34 are provided at the vertices of the rhombus in the first plane PL1. The rhombus includes a square.

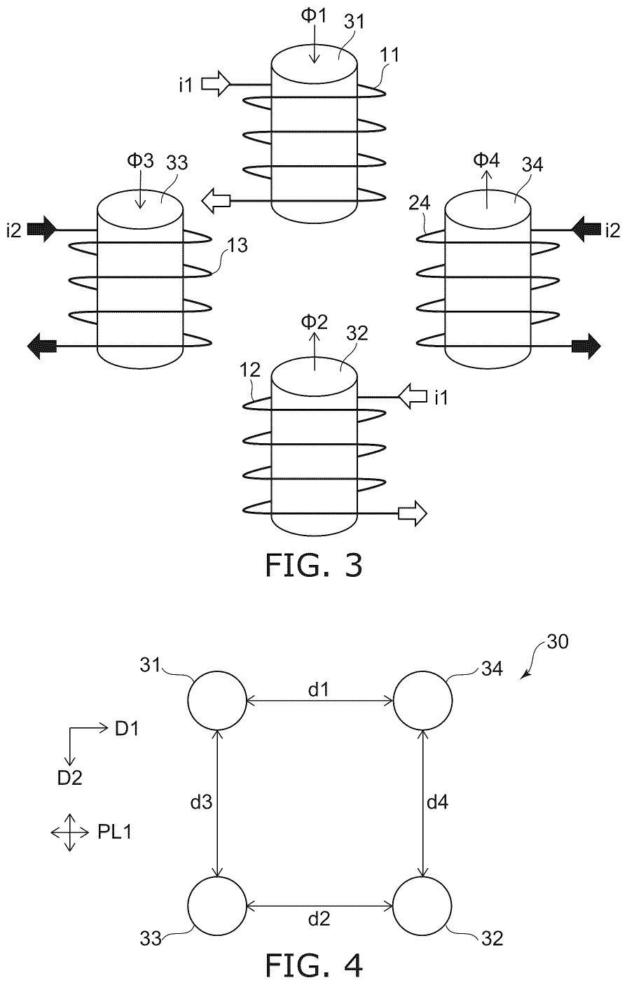

As shown in FIGS. 1 and 3, the first conductive member 10 includes a first conductive portion 11 and a second conductive portion 12. The first conductive portion 11 is wound around the first core 31 in a first winding direction. The second conductive portion 12 is wound around the second core 32 in a second winding direction. The second winding direction is opposite to the first winding direction. The winding direction is, for example, a direction in which the first conductive member 10 rotates with respect to each core when a first connection point S1 side is a starting point and a second connection point S2 side is an ending point in a plan view viewed along the crossing direction Dz1. The crossing direction Dz1 crosses the first plane PL1.

As shown in FIG. 3, for example, when the first current i1 is supplied to the first conductive member 10, the direction of the first magnetic flux Φ1 passing through the first core 31 includes a component opposite to the direction of the second magnetic flux Φ2 passing through the second core 32.

As shown in FIGS. 1 and 3, the second conductive member 20 includes a third conductive portion 23 and a fourth conductive portion 24. The third conductive portion 23 is wound around the third core 33 in a third winding direction. The fourth conductive portion 24 is wound around the fourth core 34 in a fourth winding direction. The fourth winding direction is opposite to the third winding direction. The winding direction is, for example, a direction in which the second conductive member 20 rotates with respect to each core when a third connection point S3 side is a starting point and a fourth connection point S4 side is an ending point in a plan view viewed along the crossing direction Dz1.

As shown in FIG. 3, for example, when the second current i2 is supplied to the second conductive member 20, the direction of the third magnetic flux Φ3 passing through the third core 33 includes a component opposite to the direction of the fourth magnetic flux Φ4 passing through the fourth core 34.

In the embodiment, the first conductive member 10 is wound around the first core 31 and the second core 32, and the winding directions are opposite to each other. The second conductive member 20 is wound around the third core 33 and the fourth core 34, and the winding directions are opposite to each other. The first conductive member 10 and the second conductive member 20 are conductive wires.

For example, one of the first conductive member 10 and the second conductive member 20 functions as an inductor (DC inductor) for flowing a DC current component. For example, the other of the first conductive member 10 and the second conductive member 20 functions as an inductor (AC inductor) for flowing an AC current component. The magnetic component 110 is, for example, a coupled inductor.

In the embodiment, for example, magnetic fluxes are mutually canceled (or suppressed) in the first conductive portion 11 and the second conductive portion 12. For example, the magnetic fluxes are mutually canceled (or suppressed) in the third conductive portion 23 and the fourth conductive portion 24. Loss is suppressed by the arrangement of the plurality of cores and the wiring configuration. For example, a direct current inductor and an alternating current inductor may be integrated while providing independent and efficient operation. According to the embodiment, a magnetic component that can reduce loss can be provided.

For example, the first conductive member 10 is configured to function as a DC inductor. The second conductive member 20 is configured to function as an AC inductor. In this case, the first conductive member 10 may include, for example, an edgewise coil. For example, the second conductive member 20 may include a litz wire. It is easier to obtain higher efficiency.

As shown in FIG. 2, the magnetic core portion 30 may further include a first base section 38a. The first base section 38a is connected to the first core 31, the second core 32, the third core 33, and the fourth core 34. The first base section 38a has, for example, a flat plate shape that extends in the first direction D1 and the second direction D2. The first core 31, the second core 32, the third core 33, and the fourth core 34 extend, for example, from the first base section 38a along the cross direction Dz1.

The magnetic core portion 30 may further include a second base section 38b. The first core 31, the second core 32, the third core 33, and the fourth core 34 are provided between the first base section 38a and the second base section 38b. The second base section 38b may be connected to the first core 31, the second core 32, the third core 33, and the fourth core 34. In FIG. 2, the second base section 38b is drawn separated from other parts for ease of viewing. The second base section 38b has, for example, a flat plate shape that extends in the first direction D1 and the second direction D2. The first core 31, the second core 32, the third core 33, and the fourth core 34 extend, for example, from the second base section 38b along the cross direction Dz1. The first core 31, the second core 32, the third core 33, and the fourth core 34 are located between the first base section 38a and the second base section 38b in the cross direction Dz1. In the plan view along the crossing direction Dz1, the rhombus having the first core 31, the second core 32, the third core 33, and the fourth core 34 as vertices is located inside the outer edge portion of the first base section 38a and the outer edge portion of the second base section 38b.

The first core 31, the second core 32, the third core 33, and the fourth core 34 may include, for example, ferrite. The first base section 38a and the second base section 38b may include, for example, ferrite. The first conductive member 10 and the second conductive member 20 may include, for example, copper, aluminum, silver, or gold. The materials of these parts can be modified in various ways.

As shown in FIG. 5, the first conductive portion 11 is electrically connected in series with the second conductive portion 12. The first conductive portion 11 is continuous with the second conductive portion 12. The third conductive portion 23 is electrically connected in series with the fourth conductive portion 24. The third conductive portion 23 is continuous with the fourth conductive portion 24.

As shown in FIG. 5, the magnetic component 110 may further include a first connection point S1, a second connection point S2, a third connection point S3, and a fourth connection point S4. These connection points may be terminals, for example. The first conductive portion 11 includes a first portion 11a and a first other portion 11b. The second conductive portion 12 includes a second portion 12a and a second other portion 12b. The third conductive portion 23 includes a third portion 23a and a third other portion 23b. The fourth conductive portion 24 includes a fourth portion 24a and a fourth other portion 24b. The first other portion 11b is connected to the second portion 12a. The third other portion 23b is connected to the fourth portion 24a. The first connection point S1 is connected to the first portion 11a. The second connection point S2 is connected to the second other portion 12b. The third connection point S3 is connected to the third portion 23a. The fourth connection point S4 is connected to the fourth other portion 24b.

For example, the second connection point S2 is electrically connected to the fourth connection point S4. The first conductive member 10 and the second conductive member 20 are electrically connected in parallel.

The first conductive portion 11 and the second conductive portion 12 function as, for example, a DC inductor. The third conductive portion 23 and the fourth conductive portion 24 function as, for example, an AC inductor. The first conductive portion 11 and the second conductive portion 12 have, for example, a first inductance L_{DC}. The third conductive portion 23 and the fourth conductive portion 24 have, for example, a second inductance L_{AC}.

The magnetic component 110 according to the embodiment can be applied to an electric circuit 210 (see FIG. 5). The Electric circuit 210 includes the magnetic component 110 according to the embodiment and a first capacitor 41. The first capacitor 41 is configured to be coupled to the second conductive member 20, for example. The first capacitor 41 has a capacitance C_{hf}.

As shown in FIG. 5, the first capacitor 41 includes a first capacitor end 41a and a first other capacitor end 41b. As already explained, the first other portion 11b is connected to the second portion 12a. The third other portion 23b is connected to the fourth portion 24a. The second other portion 12b is connected to the fourth other portion 24b. The first other capacitor end 41b is connected to the third portion 23a. The first capacitor end 41a is connected to the first portion 11a.

As shown in FIG. 5, the electric circuit 210 may include a first terminal T1 and a second terminal T2. The first terminal T1 is electrically connected to the first portion 11a (and the first capacitor end 41a). The second terminal T2 is electrically connected to the second other portion 12b (and the fourth other portion 24b). For example, the first terminal T1 may function as an input terminal. For example, the second terminal T2 may function as an output terminal.

In the chopper circuit and the like in the first reference example, one inductor (magnetic component) is provided. On the other hand, a second reference example may be considered in which a DC inductor and an AC inductor are provided.

FIG. 6 is an equivalent circuit diagram illustrating the magnetic component of the second reference example.

As shown in FIG. 6, the magnetic component 119 of the second reference example is provided with a coil having a first inductance L_{DC} and a coil having a second inductance L_{AC}. In the magnetic component 119, magnetic fluxes in mutually opposite directions are not formed. Such a magnetic component 119 is combined with a capacitor having a capacitance C_{hf}. In the second reference example, for example, a DC inductor and an AC inductor are provided independently of each other.

In contrast, the magnetic component 110 according to the embodiment is a coupled inductor. Then, a wiring configuration that cancels the magnetic flux is applied.

The loss in the above second reference example can be reduced to about 85% of the loss in the above first reference example. The volume of the magnetic component in the above second reference example can be reduced to about 94% of the volume of the magnetic component in the above first reference example.

The loss in the magnetic component 110 according to the embodiment can be reduced to about 82% of the loss in the magnetic component 119 of the first reference example. The volume of the magnetic component 110 according to the embodiment can be reduced to about 79% of the volume of the magnetic component 119 of the first reference example.

Thus, in the embodiment, loss can be reduced. Volume can be reduced. For example, the height of the magnetic component can be suppressed. The height is the length of the magnetic component 110 in the crossing direction Dz1 crossing a plane including the first direction D1 and the second direction D2.

As shown in FIG. 1, in the magnetic component 110, at least a part of the first conductive portion 11 is provided around the first core 31 in the first plane PL1 including the first direction D1 and the second direction D2. At least a part of the second conductive portion 12 is provided around the second core 32 in the first plane PL1. At least a part of the third conductive portion 23 is provided around the third core 33 in the first plane PL1. At least a part of the fourth conductive portion 24 is provided around the fourth core 34 in the first plane PL1. The state in which the conductive portion is wound can be modified in various ways.

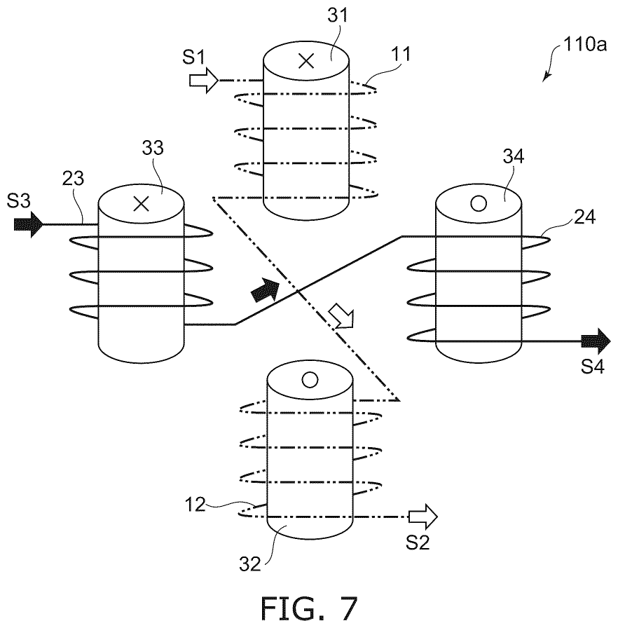

FIGS. 7 to 10 are schematic perspective views illustrating a magnetic component according to the first embodiment.

As shown in FIG. 7, in a magnetic component 110a according to the embodiment, the first conductive portion 11 is continuously wound around the first core 31 in a first number of turns. The second conductive portion 12 is continuously wound around the second core 32 in a second number of turns. The third conductive portion 23 is continuously wound around the third core 33 in a third number of turns. The fourth conductive portion 24 is continuously wound around the fourth core 34 in a fourth number of turns.

In this example, for example, the first number of turns, the second number of turns, the third number of turns, and the fourth number of turns are 2 or more. In the embodiments, for example, the first number of turns is the same as the second number of turns. For example, the third number of turns is the same as the fourth number of turns. The magnetic flux is easily canceled. For convenience of drawing, the first to fourth turns may be shown increased or decreased by half a turn.

In the magnetic component 110a, the first connection point S1 is provided near the first core 31. The second connection point S2 is provided near the second core 32. The third connection point S3 is provided near the third core 33. The fourth connection point S4 is provided near the fourth core 34.

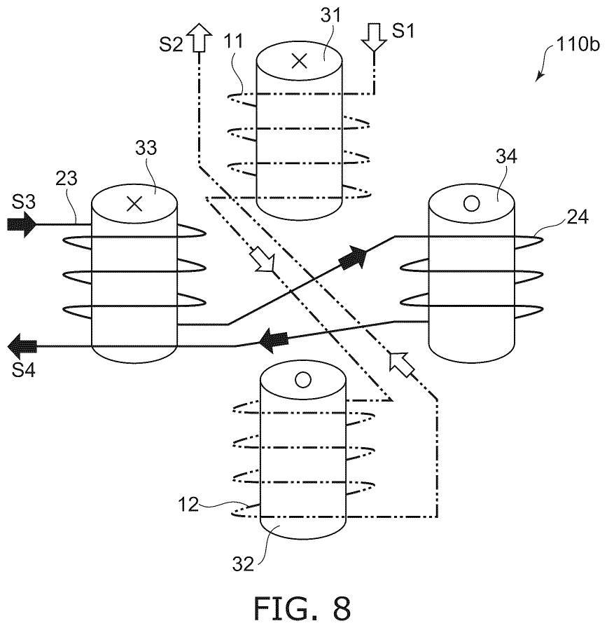

As shown in FIG. 8, in a magnetic component 110b according to the embodiment, the first connection point S1 and the second connection point S2 are provided near the first core 31. The third connection point S3 and the fourth connection point S4 are provided near the third core 33.

In the magnetic component 110, the magnetic component 110a, and the magnetic component 110b, the first number of turns may be greater than the third number of turns. Thereby, for example, the first inductance L_{DC} (direct current) can be made sufficiently larger than the second inductance L_{AC} (alternating current). Thereby, alternating current is suppressed from flowing through the first conductive member 10. It becomes easy to obtain low loss. In one example, the first number of turns may be three or more times the third number of turns. Low loss can be effectively obtained.

For example, the first inductance L_{DC} of the first conductive member 10 may be nine times or more the second inductance L_{AC} of the second conductive member 20.

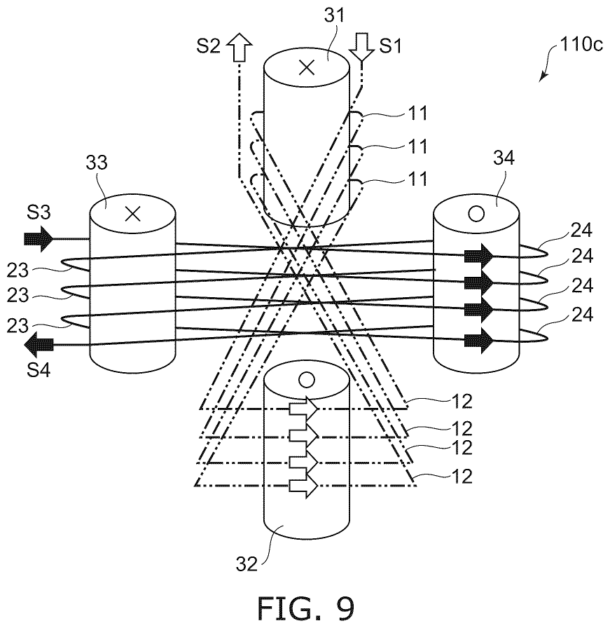

As shown in FIG. 9, in a magnetic component 110c according to the embodiment, a plurality of first conductive portions 11 and a plurality of second conductive portions 12 are provided. One of the plurality of first conductive portions 11 is provided between one of the plurality of second conductive portions 12 and another one of the plurality of second conductive portions 12. One of the plurality of second conductive portions 12 is provided between one of the plurality of first conductive portions 11 and another one of the plurality of first conductive portions 11.

In the magnetic component 110c, a plurality of third conductive portions 23 may be provided, and a plurality of the fourth conductive portions 24 may be provided. One of the plurality of third conductive portions 23 is provided between one of the plurality of fourth conductive portions 24 and another one of the plurality of fourth conductive portions 24. One of the plurality of fourth conductive portions 24 is provided between one of the plurality of third conductive portions 23 and another one of the plurality of third conductive portions 23.

In the magnetic component 110c, the first connection point S1 and the second connection point S2 are provided near the first core 31. The third connection point S3 and the fourth connection point S4 are provided near the third core 33.

As shown in FIG. 10, in a magnetic component 110d according to the embodiment, a plurality of first conductive portions 11, a plurality of second conductive portions 12, a plurality of third conductive portions 23, and a plurality of fourth conductive portions. 24 are provided. In the magnetic component 110d, the first connection point S1 is provided near the first core 31. The second connection point S2 is provided near the second core 32. The third connection point S3 is provided near the third core 33. The fourth connection point S4 is provided near the fourth core 34.

### Second Embodiment

The second embodiment relates to the electric circuit 210 (see FIG. 5). As already explained, the electric circuit 210 includes the magnetic components (110, 110a to 110d, etc.) according to the embodiment and the first capacitor 41. The first capacitor 41 is configured to be coupled to the second conductive member 20, for example. The first capacitor 41 has a capacitance C_{hf}.

The switching frequency is defined as f_{sw}. The inductance of the second conductive member 20 is defined as L_{AC}. At this time, the capacitance C_{hf} of the first capacitor 41 is preferably smaller than 1/{4π²·(f_{sw})²·L_{AC}}. Thereby, the second conductive member 20 fully functions as an inductor at the switching frequency (target frequency). For example, the capacitance C_{hf} is ⅕ or less of 1/{4π²·(f_{sw})²·L_{AC}}. The switching frequency f_{sw} corresponds to the operating frequency of a power conversion circuit (described later) including the electric circuit 210.

### Third Embodiment

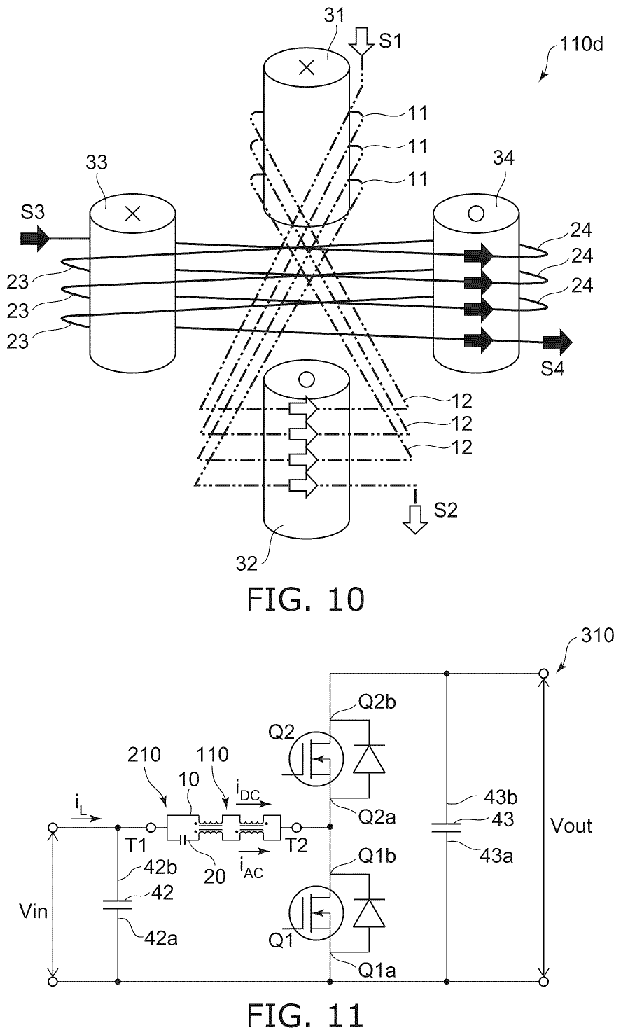

FIG. 11 is an equivalent circuit diagram illustrating a power conversion circuit according to a third embodiment.

As shown in FIG. 11, a power conversion circuit 310 according to the embodiment includes the electric circuit 210 according to the second embodiment, a first switching element Q1, and a second switching element Q2. The second switching element Q2 is electrically connected in series with the first switching element Q1. The drive frequency of the first switching element Q1 and the second switching element Q2 corresponds to the switching frequency f_{sw}.

The first switching element Q1 includes a first switch portion Q1a and a first other switch portion Q1b. The second switching element Q2 includes a second switch portion Q2a and a second other switch portion Q2b. The first other switch portion Q1b is electrically connected to the second switch portion Q2a.

The electric circuit 210 includes the first terminal T1 and the second terminal T2. As already explained, the first terminal T1 is electrically connected to the first portion 11a (see FIG. 5). The second terminal T2 is electrically connected to the second other portion 12b. The second terminal T2 is electrically connected to the first other switch portion Q1b and the second switch portion Q2a.

The power conversion circuit 310 may further include a second capacitor 42. The second capacitor 42 includes a second capacitor end 42a and a second other capacitor end 42b. The second capacitor end 42a is electrically connected to the first switch portion Q1a. The second other capacitor end 42b is electrically connected to the first terminal T1.

The power conversion circuit 310 may further include a third capacitor 43. The third capacitor 43 includes a third capacitor end 43a and a third other capacitor end 43b. The third capacitor end 43a is electrically connected to the first switch portion Q1a. The third other capacitor end 43b is electrically connected to the second other switch portion Q2b.

For example, the potential between the second capacitor end 42a and the second other capacitor end 42b is a first voltage Vin. The potential between the third capacitor end 43a and the third other capacitor end 43b is a second voltage Vout. An input current it is supplied to the first terminal T1. A first partial current i_{DC} flows through the first conductive member 10. A second partial current i_{AC} flows through the second conductive member 20. In the power conversion circuit 310, for example, the first voltage Vin is converted into the second voltage Vout. For example, voltage conversion is performed in the power conversion circuit 310.

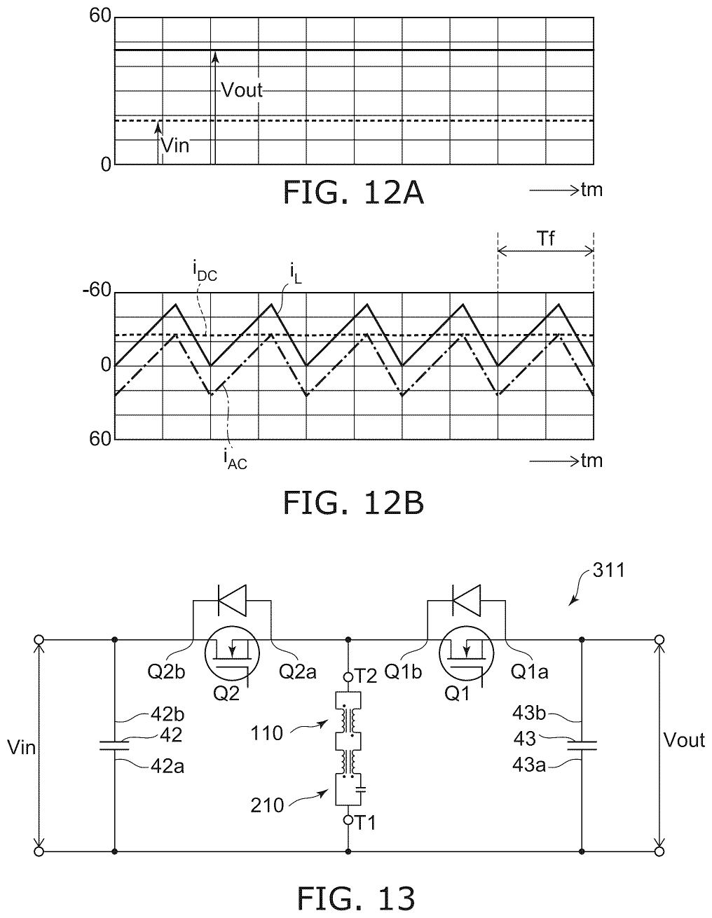

FIGS. 12A and 12B are graphs illustrating the characteristics of the power conversion circuit according to the third embodiment.

The horizontal axis of these figures is time tm. FIG. 12A illustrates the first voltage Vin and the second voltage Vout. The vertical axis in FIG. 12A is voltage. FIG. 12B illustrates the input current i_{L}, the first partial current i_{DC}, and the second partial current i_{AC}. The vertical axis in FIG. 12B is current.

As shown in FIG. 12B, the input current it is separated into the first partial current i_{DC}, which is a DC component, and the second partial current i_{AC}, which is an AC component. The period Tf of the AC component may be, for example, not less than 0.1 μs and not more than 10 μs. The voltage is converted by the first partial current i_{DC} and the second partial current i_{AC}.

As shown in FIG. 12A, the second voltage Vout (output) is different from the first voltage Vin (input). The first voltage Vin is, for example, 18V. The second voltage Vout is, for example, 48V. The power conversion circuit 310 corresponds to, for example, a chopper circuit.

FIGS. 13 to 16 are equivalent circuit diagrams illustrating power conversion circuits according to the third embodiment.

As shown in FIG. 13, in a power conversion circuit 311 according to the embodiment, the second switching element Q2 is connected in series with the first switching element Q1. The second terminal T2 is connected to a connection point between the first other switch portion Q1b and the second switch portion Q2a. The first terminal T1 is connected to a connection point between the second capacitor end 42a and the third capacitor end 43a. The power conversion circuit 311 corresponds to, for example, a buck-boost chopper circuit.

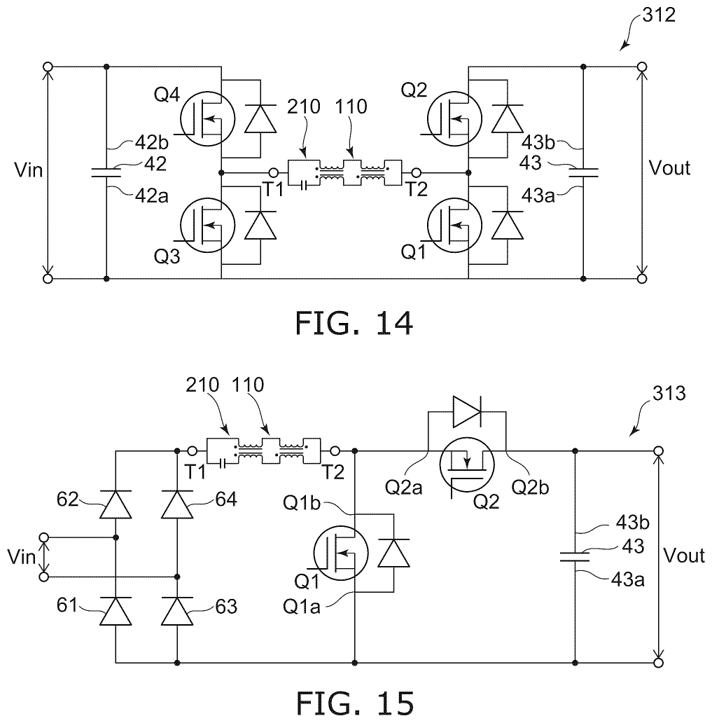

As shown in FIG. 14, a power conversion circuit 312 according to the embodiment includes a third switching element Q3 and a fourth switching element Q4. The fourth switching element Q4 is connected in series with the third switching element Q3. The first terminal T1 is electrically connected to a connecting portion of the third switching element Q3 and the fourth switching element Q4. The second terminal T2 is electrically connected to a connection portion between the first switching element Q1 and the second switching element Q2. The third switching element Q3 and the fourth switching element Q4 are connected in parallel with the second capacitor 42. The first switching element Q1 and the second switching element Q2 are connected in parallel with the third capacitor 43. The power conversion circuit 312 corresponds to, for example, an H-bridge circuit.

As shown in FIG. 15, in a power conversion circuit 313 according to the embodiment, the second terminal T2 is electrically connected to the first other switch portion Q1b and the second switch portion Q2a. The power conversion circuit 313 includes a first rectifying element 61, a second rectifying element 62, a third rectifying element 63, and a fourth rectifying element 64. The second rectifying element 62 is connected in series with the first rectifying element 61. The fourth rectifying element 64 is connected in series with the third rectifying element 63. A circuit including the first rectifying element 61 and the second rectifying element 62 is connected in parallel with a circuit including the third rectifying element 63 and the fourth rectifying element 64. A connection point between the second rectifying element 62 and the fourth rectifying element 64 is connected to the first terminal T1. A connection point between the first rectifying element 61 and the third rectifying element 63 is connected to the first switch portion Q1a. The power conversion circuit 313 corresponds to, for example, a boost PFC (Power Factor Correction) circuit.

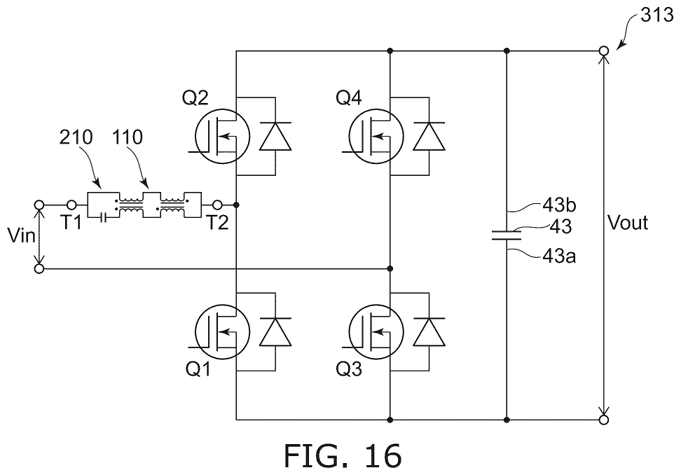

As shown in FIG. 16, in a power conversion circuit 313 according to the embodiment, the second switching element Q2 is connected in series with the first switching element Q1. The fourth switching element Q4 is connected in series with the third switching element Q3. A circuit including the first switching element Q1 and the second switching element Q2 is connected in parallel with a circuit including the third switching element Q3 and the fourth switching element Q4. The second terminal T2 is connected to a connection point between the first switching element Q1 and the second switching element Q2, and a connection point between the third switching element Q3 and the fourth switching element Q4. The power conversion circuit 313 corresponds to, for example, a totem pole PFC circuit.

The magnetic component according to the embodiment may be applied to various circuits.

The embodiments may include, for example, the following Technical proposals:

### (Technical Proposal 1)

A magnetic component, comprising:
a magnetic core portion including a first core, a second core, a third core, and a fourth core, a first direction from the first core to the fourth core crossing a second direction from the first core to the third core, a direction from the third core to the second core being along the first direction, a direction from the fourth core to the second core being along the second direction, a first distance between the first core and the fourth core being same as a third distance between the first core and the third core, the first distance being same as a second distance between the third core and the second core, the first distance being same as a fourth distance between the fourth core and the second core;
a first conductive member including a first conductive portion and a second conductive portion, the first conductive portion being wound around the first core in a first winding direction, the second conductive portion being wound around the second core in a second winding direction, the second winding direction being opposite to the first winding direction; and
a second conductive member including a third conductive portion and a fourth conductive portion, the third conductive portion being wound around the third core in a third winding direction, the fourth conductive portion being wound around the fourth core in a fourth winding direction, the fourth winding direction being opposite to the third winding direction.

### (Technical Proposal 2)

The magnetic component according to Technical proposal 1, wherein
when a first current is supplied to the first conductive member, a direction of the first magnetic flux passing through the first core includes a component opposite to a direction of the second magnetic flux passing through the second core, and
when a second current is supplied to the second conductive member, a direction of the third magnetic flux passing through the third core includes a component opposite to a direction of the fourth magnetic flux passing through the fourth core.

### (Technical Proposal 3)

The magnetic component according to Technical proposal 1 or 2, wherein
the first conductive member is configured to function as a DC inductor, and
the second conductive member is configured to function as an AC inductor.

### (Technical Proposal 4)

The magnetic component according to any one of Technical proposals 1-3, wherein
the first conductive member includes an edgewise coil, and
the second conductive member includes a litz wire.

### (Technical Proposal 5)

The magnetic component according to any one of Technical proposals 1-4, wherein
at least a part of the first conductive portion is provided around the first core in a first plane including the first direction and the second direction,
at least a part of the second conductive portion is provided around the second core in the first plane,
at least a part of the third conductive portion is provided around the third core in the first plane, and
at least a part of the fourth conductive portion is provided around the fourth core in the first plane.

### (Technical Proposal 6)

The magnetic component according to any one of Technical proposals 1-5, wherein
the first conductive portion is continuously wound around the first core in a first number of turns,
the second conductive portion is continuously wound around the second core in a second number of turns,
the first number of turns is same as the second number of turns,
the third conductive portion is continuously wound around the third core in a third number of turns,
the fourth conductive portion is continuously wound around the fourth core in a fourth number of turns, and
the third number of turns is same as the fourth number of turns.

### (Technical Proposal 7)

The magnetic component according to Technical proposal 6, wherein
the first number of turns is greater than the third number of turns.

### (Technical Proposal 8)

The magnetic component according to Technical proposal 6, wherein
the first number of turns is three times or more the third number of turns.

### (Technical Proposal 9)

The magnetic component according to any one of Technical proposals 1-5, wherein
a plurality of the first conductive portions are provided,
a plurality of the second conductive portions are provided,
one of the plurality of first conductive portions is provided between one of the plurality of second conductive portions and another one of the plurality of second conductive portions, and
the one of the plurality of second conductive portions is provided between the one of the plurality of first conductive portions and another one of the plurality of first conductive portions.

### (Technical Proposal 10)

The magnetic component according to Technical proposal 9, wherein
a plurality of the third conductive portions are provided,
a plurality of the fourth conductive portions are provided,
one of the plurality of third conductive portions is provided between one of the plurality of fourth conductive portions and another one of the plurality of fourth conductive portions, and
the one of the plurality of fourth conductive portions is provided between the one of the plurality of third conductive portions and another one of the plurality of third conductive portions.

### (Technical Proposal 11)

The magnetic component according to any one of Technical proposals 1-10, wherein
the magnetic core portion further includes a first base section, and
the first base section is connected to the first core, the second core, the third core, and the fourth core.

### (Technical Proposal 12)

The magnetic component according to Technical proposal 11, wherein
the magnetic core portion further includes a second base section,
the first core, the second core, the third core, and the fourth core are provided between the first base section and the second base section, and
the second base section is connected to the first core, the second core, the third core, and the fourth core.

### (Technical Proposal 13)

The magnetic component according to any one of Technical proposals 1-12, wherein
a first inductance of the first conductive member is three times or more a second inductance of the second conductive member.

### (Technical Proposal 14)

The magnetic component according to any one of Technical proposals 1-13, further comprising:
a first connection point;
a second connection point;
a third connection point; and
a fourth connection point,
the first conductive portion including a first portion and a first other portion,
the second conductive portion including a second portion and a second other portion,
the third conductive portion including a third portion and a third other portion,
the fourth conductive portion including a fourth portion and a fourth other portion,
the first other portion being connected to the second portion,
the third other portion being connected to the fourth portion,
the first connection point being connected to the first portion,
the second connection point being connected to the second other portion,
the third connection point being connected to the third portion, and
the fourth connection point being connected to the fourth other portion.

### (Technical Proposal 15)

The magnetic component according to Technical proposal 14, wherein
the second connection point is electrically connected to the fourth connection point.

### (Technical Proposal 16)

An electric circuit, comprising:
the magnetic component according to any one of Technical proposals 1-13; and
a first capacitor,
the first capacitor being configured to be coupled to the second conductive member.

### (Technical Proposal 17)

The electric circuit according to Technical proposal 16, wherein
the first conductive portion includes a first portion and a first other portion,
the second conductive portion includes a second portion and a second other portion,
the third conductive portion includes a third portion and a third other portion,
the fourth conductive portion includes a fourth portion and a fourth other portion,
the first capacitor includes a first capacitor end and a first other capacitor end,
the first other portion is connected to the second portion,
the third other portion is connected to the fourth portion,
the second other portion is connected to the fourth other portion,
the first other capacitor end is connected to the third portion, and
the first capacitor end is connected to the first portion.

### (Technical Proposal 18)

The electric circuit according to Technical proposal 17, wherein
a switching frequency is f_{sw},
an inductor of the second conductive member is L_{AC}, and
the capacitance C_{hf} of the first capacitor is ⅕ or less of 1/{4π²·(f_{sw})²·L_{AC}}.

### (Technical Proposal 19)

A power conversion circuit, comprising:
the electric circuit according to Technical proposal 17 or 18;
a first switching element including a first switch portion and a first other switch portion; and
a second switching element including a second switch portion and a second other switch portion,
the electrical circuit including a first terminal and a second terminal,
the first terminal being electrically connected to the first portion,
the second terminal being electrically connected to the second other portion, and
the second terminal being electrically connected to the first other switch portion and the second switch portion.

### (Technical Proposal 20)

The power conversion circuit according to Technical proposal 19, further comprising:
a second capacitor including a second capacitor end and a second other capacitor end,
the second capacitor end being connected to the first switch portion, and
the second other capacitor end being connected to the first terminal.

According to the embodiment, a magnetic component, an electric circuit, and a power conversion circuit that can reduce loss can be provided.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in the magnetic components, the electric circuits, and the power conversion circuits, such as core portions, cores, conductive members, capacitors, switching elements, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic components, all electric circuits, and all power conversion circuits practicable by an appropriate design modification by one skilled in the art based on the magnetic components, the electric circuits, and the power conversion circuits, described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic component, comprising:
a magnetic core portion including a first core, a second core, a third core, and a fourth core, a first direction from the first core to the fourth core crossing a second direction from the first core to the third core, a direction from the third core to the second core being along the first direction, a direction from the fourth core to the second core being along the second direction, a first distance between the first core and the fourth core being same as a third distance between the first core and the third core, the first distance being same as a second distance between the third core and the second core, the first distance being same as a fourth distance between the fourth core and the second core;
a first conductive member including a first conductive portion and a second conductive portion, the first conductive portion being wound around the first core in a first winding direction, the second conductive portion being wound around the second core in a second winding direction, the second winding direction being opposite to the first winding direction; and
a second conductive member including a third conductive portion and a fourth conductive portion, the third conductive portion being wound around the third core in a third winding direction, the fourth conductive portion being wound around the fourth core in a fourth winding direction, the fourth winding direction being opposite to the third winding direction.

2. The magnetic component according to claim 1, wherein
when a first current is supplied to the first conductive member, a direction of the first magnetic flux passing through the first core includes a component opposite to a direction of the second magnetic flux passing through the second core, and
when a second current is supplied to the second conductive member, a direction of the third magnetic flux passing through the third core includes a component opposite to a direction of the fourth magnetic flux passing through the fourth core.

3. The magnetic component according to claim 1, wherein
the first conductive member is configured to function as a DC inductor, and
the second conductive member is configured to function as an AC inductor.

4. The magnetic component according to claim 1, wherein
the first conductive member includes an edgewise coil, and
the second conductive member includes a litz wire.

5. The magnetic component according to claim 1, wherein
at least a part of the first conductive portion is provided around the first core in a first plane including the first direction and the second direction,
at least a part of the second conductive portion is provided around the second core in the first plane,
at least a part of the third conductive portion is provided around the third core in the first plane, and
at least a part of the fourth conductive portion is provided around the fourth core in the first plane.

6. The magnetic component according to claim 1, wherein
the first conductive portion is continuously wound around the first core in a first number of turns,
the second conductive portion is continuously wound around the second core in a second number of turns,
the first number of turns is same as the second number of turns,
the third conductive portion is continuously wound around the third core in a third number of turns,
the fourth conductive portion is continuously wound around the fourth core in a fourth number of turns, and
the third number of turns is same as the fourth number of turns.

7. The magnetic component according to claim 6, wherein
the first number of turns is greater than the third number of turns.

8. The magnetic component according to claim 6, wherein
the first number of turns is three times or more the third number of turns.

9. The magnetic component according to claim 1, wherein
a plurality of the first conductive portions are provided,
a plurality of the second conductive portions are provided,
one of the plurality of first conductive portions is provided between one of the plurality of second conductive portions and another one of the plurality of second conductive portions, and
the one of the plurality of second conductive portions is provided between the one of the plurality of first conductive portions and another one of the plurality of first conductive portions.

10. The magnetic component according to claim 9, wherein
a plurality of the third conductive portions are provided,
a plurality of the fourth conductive portions are provided,
one of the plurality of third conductive portions is provided between one of the plurality of fourth conductive portions and another one of the plurality of fourth conductive portions, and
the one of the plurality of fourth conductive portions is provided between the one of the plurality of third conductive portions and another one of the plurality of third conductive portions.

11. The magnetic component according to claim 1, wherein
the magnetic core portion further includes a first base section, and
the first base section is connected to the first core, the second core, the third core, and the fourth core.

12. The magnetic component according to claim 11, wherein
the magnetic core portion further includes a second base section,
the first core, the second core, the third core, and the fourth core are provided between the first base section and the second base section, and
the second base section is connected to the first core, the second core, the third core, and the fourth core.

13. The magnetic component according to claim 1, wherein
a first inductance of the first conductive member is three times or more a second inductance of the second conductive member.

14. The magnetic component according to claim 1, further comprising:
a first connection point;
a second connection point;
a third connection point; and
a fourth connection point,
the first conductive portion including a first portion and a first other portion,
the second conductive portion including a second portion and a second other portion,
the third conductive portion including a third portion and a third other portion,
the fourth conductive portion including a fourth portion and a fourth other portion,
the first other portion being connected to the second portion,
the third other portion being connected to the fourth portion,
the first connection point being connected to the first portion,
the second connection point being connected to the second other portion,
the third connection point being connected to the third portion, and
the fourth connection point being connected to the fourth other portion.

15. The magnetic component according to claim 14, wherein
the second connection point is electrically connected to the fourth connection point.

16. An electric circuit, comprising:
the magnetic component according to claim 1; and
a first capacitor,
the first capacitor being configured to be coupled to the second conductive member.

17. The electric circuit according to claim 16, wherein
the first conductive portion includes a first portion and a first other portion,
the second conductive portion includes a second portion and a second other portion,
the third conductive portion includes a third portion and a third other portion,
the fourth conductive portion includes a fourth portion and a fourth other portion,
the first capacitor includes a first capacitor end and a first other capacitor end,
the first other portion is connected to the second portion,
the third other portion is connected to the fourth portion,
the second other portion is connected to the fourth other portion,
the first other capacitor end is connected to the third portion, and
the first capacitor end is connected to the first portion.

18. The electric circuit according to claim 17, wherein
a switching frequency is f_{sw},
an inductor of the second conductive member is L_{AC}, and
the capacitance C_{hf} of the first capacitor is ⅕ or less of 1/{4π²·(f_{sw})²·L_{AC}}.

19. A power conversion circuit, comprising:
the electric circuit according to claim 17;
a first switching element including a first switch portion and a first other switch portion; and
a second switching element including a second switch portion and a second other switch portion,
the electrical circuit including a first terminal and a second terminal,
the first terminal being electrically connected to the first portion,
the second terminal being electrically connected to the second other portion, and
the second terminal being electrically connected to the first other switch portion and the second switch portion.

20. The power conversion circuit according to claim 19, further comprising:
a second capacitor including a second capacitor end and a second other capacitor end,
the second capacitor end being connected to the first switch portion, and
the second other capacitor end being connected to the first terminal.
